(19) United States
(12) Patent Application Publication
(10) Pub. No.: US 2008/0075310 A1
(43) Pub. Date: Mar. 27, 2008

(54) Hearing aid device

(76) Inventors: Georg-Erwin Arndt, Obermichelbach (DE); Markus Hornig, Pinzberg (DE); Frank Koch, Erlangen (DE); Marco Lederer, Hirschaid/Erlach (DE); Christian Weistenhofer, Bubenreuth (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/823,070

(22) Filed: Jun. 26, 2007

(30) Foreign Application Priority Data
Jun. 28, 2006 (DE) 10 2006 029 726.1

(51) Int. Cl. H04R 25/00

(52) U.S. Cl. 381/328

(57) ABSTRACT

There is described a hearing aid device, in particular a hearing aid such as, for example, an ITE device, comprising a section which can be provided in or on an ear and from which a multi-channel tube projects, the free end section of which can be inserted into an outer auditory canal of the ear, wherein an earpiece channel of the multi-channel tube is acoustically connected to an earpiece and an auditory canal microphone channel of the multi-channel tube is acoustically connected to an auditory canal microphone, in each case inside the hearing aid device.

The invention relates to a hearing aid device, in particular a hearing aid, such as, for example, an in-the-ear (ITE) hearing aid or a behind-the-ear (BTE) hearing aid.

In order to accommodate the aesthetic needs of a wearer of a hearing aid device, such devices should be as inconspicuous as possible externally on a wearer. Consequently, a miniaturization of the hearing aid devices is necessary on the one hand, while on the other hand said devices are intended to provide an optimally diverse set of functions together with high-quality processing, within the hearing aid devices, of the signals that are necessary for improving hearing ability. These criteria represent opposing requirements, said requirements being exceptionally high in particular in the case of ITE hearing aids.

Hearing aid devices can give rise to a blocking effect—known as the occlusion effect—which is experienced as unpleasant by the wearer since the space for a pressure equalization hole—known as venting—often cannot be dimensioned to be sufficiently large in this case. Due to this occlusion the hearing aid wearer's own voice sounds louder and hollow. The occlusion effect occurs, for example, as a result of the ITE hearing aid being inserted into the ear or as a result of an otoplastic of a BTE hearing aid.

Venting diameters up to 1 mm serve almost exclusively for equalizing pressure when an ITE or, as the case may be, a section of the hearing aid device that is to be introduced into the ear is inserted into the ear. Furthermore such small venting diameters serve to equalize the pressure during short-lived pressure fluctuations in the environment, such as can occur, for example, in an aircraft, when closing doors, in elevators, or when swallowing. Venting diameters up to 3 mm have a great influence on a low frequency response, but also reduce the occlusion effect in the auditory canal when the hearing aid device is placed in the ear or on the auricle and said device at least partially blocks the outer auditory canal.

All holes and channels in a hearing aid device are to be regarded acoustically as “long tubes” and possess low-pass characteristics. Holes with a larger diameter have greater cut-off frequencies and a lower attenuation. In this case, for example, a necessary baffle function between an earpiece (loudspeaker) of the hearing aid device or an emitting sound tube and an ambient microphone in the vicinity of the ear can no longer be fulfilled as of a specific acoustic amplification, resulting in an acoustic feedback or “whistling”. Said acoustic feedback is also related to the size of the venting.

In order to limit the occlusion, the acoustic feedback and other acoustic problems with a hearing aid device, methods and devices are known which pick up the acoustic conditions in the outer auditory canal by means of an auditory canal microphone and provide a means of signal processing within the hearing aid device in order to minimize the known problems. Methods of this kind, which require an auditory canal microphone in order to operate a hearing aid device, are known for example from DE 698 26 331 T2 and EP 1 251 714 A2.

A hearing aid device that is to be produced economically and efficiently, in particular an ITE hearing aid having an auditory canal microphone, must be constructed in as space-saving a manner as possible so that the number of people that can be supplied therewith is as large as possible, since their auricle and auditory canal shape and size can vary greatly from one another. Thus, for example, the volume of the auditory canal in an average male is approx. 2 cm³, whereas in the case of a female this volume is reduced on average to a half thereof. Furthermore the size of a hearing aid device is dependent on the size of the components to be accommodated therein (owing to the degree of hearing impairment to be treated and a functionality of the hearing aid device), i.e. also on the size of the auditory canal microphone, as well as on the manner in which the auditory canal microphone is acoustically connected to the outer auditory canal.

DE 39 08 673 A1 discloses a hearing aid device, in particular an in-the-ear hearing aid, which reduces the risk of acoustical feedback leading to “whistling”. For this purpose the in-the-ear hearing aid has a microphone for receiving ambient sound and a microphone for receiving sound from the auditory canal, the signals of both of which are processed further by a signal processor and made available to an earpiece. In this case the auditory canal microphone sits laterally at a venting channel of the in-the-ear hearing aid. Said lateral (i.e. provided in a side wall of the venting channel) auditory canal microphone forms a part of the wall of the venting channel and does not project into said venting channel, with the result that said venting channel is not reduced in its cross-section and consequently an occlusion caused by the hearing aid is not magnified.

The position of the auditory canal microphone in a wall of the vent canal is unfavorable, since this cannot adequately reproduce the sound wave spectrum of the auditory canal. Generally it is better if the auditory canal microphone is coupled as directly as possible to the auditory canal. A further problem is that an opening in the wall is not accessible to the auditory canal microphone and consequently is difficult to protect against cerumen, and so is difficult to clean.

AT E 76 549 B discloses a system and a method for compensating hearing deficiencies by means of an ITE hearing aid in the plastic casing of which an auditory canal microphone, a low-frequency loudspeaker and a high-frequency loudspeaker are accommodated. The respective sound tubes for the auditory canal microphone, the low-frequency loudspeaker and the high-frequency loudspeaker are embodied separately from one another in the casing of the ITE hearing aid.

Due to the comparatively thick free end section of the ITE which can be inserted into the auditory canal and occludes the latter completely, it is not possible to couple the auditory canal microphone, the low-frequency loudspeaker and the high-frequency loudspeaker directly to the sound conditions in the auditory canal.

It is therefore an object of the invention to provide an improved hearing aid device. In particular an auditory canal microphone should be coupled as directly as possible to the sound conditions in an auditory canal in order thereby to achieve better signal processing within the hearing aid device, the aim being to constrict the auditory canal as little as possible.

The object of the invention is achieved by means of a hearing aid device which has a section which can be provided in or on an ear and out of which there projects a multi-chamber or multi-channel tube, the free end of which can be introduced or inserted into an outer auditory canal of the ear, wherein a first duct (first channel, earpiece channel) of the multi-channel tube is acoustically connected to an earpiece within the hearing aid device and during operation of the hearing aid device sound is transported from the earpiece into the auditory canal, and a second duct (second channel, auditory canal microphone channel) of the multi-channel tube is acoustically connected to an auditory canal microphone within the hearing aid device and during operation of the hearing aid device sound is transported from the auditory canal to the auditory canal microphone.

According to the invention the multi-channel tube is at least a two-channel tube which transports sound from the earpiece into the auditory canal and sound from the auditory canal to the auditory canal microphone in parallel. According to the invention the multi-channel tube can also have a third channel, preferably what is referred to as a venting channel, which leads to a venting of the hearing aid device. Furthermore a multi-channel tube which has more than three channels or more than three ducts is, of course, also possible. In general the channels of the multi-channel tube can handle any acoustic tasks. Thus, for example, it is possible for two channels to direct sound from the earpiece into the auditory canal and/or for two channels to direct sound from the auditory canal to one or two auditory canal microphones. In this arrangement a venting channel can, of course, also be provided.

The multi-channel tube preferably consists of an outer wall and an inner partition wall which separates the hollow volumes (preferably two or three) that extend along the multi-chamber tube. In this case the cross-sectional areas of the channels or the hollow volumes of the channels can be different in terms of their size and/or shape, with a cross-sectional area of the channel for the auditory canal microphone preferably being smaller than or equal to a cross-sectional area for the channel of the earpiece. If a venting channel is provided in the multi-chamber tube, its cross-sectional area is preferably smaller than or equal in size to that of the channel for the auditory canal microphone.

A choice of material for the multi-channel tube and a dimensioning of the multi-channel tube in terms of its cross-sections and also its sound transport lengths (i.e. channel volumes) must ensure that the acoustic crosstalk between the channels is as low as possible, but at least low enough to ensure that no disadvantages result in respect of the acoustic qualities of the hearing aid device. It is also possible, e.g. because of a small thickness of the inner partition wall of the multi-channel tube, to allow a certain degree of crosstalk, whereby in the worst case this is only allowed to become so great that it can be brought back down to an acceptable level by means of the available auditory canal microphone data and the capacity of the signal processing means.

By means of the multi-channel tube according to the invention it is now possible to couple an auditory canal microphone directly to an outer auditory canal of the human ear and in this way to obtain a good information base for a further processing of the sound waves recorded by the auditory canal microphone.

The tubes used for hearing aid devices have an inner diameter of typically approx. 1.4 mm and an outer diameter of typically approx. 2.4 mm. Compared with the use of two tubes, i.e. one for the auditory canal microphone and one for the earpiece—a space saving by at least one wall diameter is produced by means of a two-channel tube, which—given the same cross-sectional area of the channels—is dependent on a diameter of the inner partition wall of the two-channel tube. If it is assumed that the outer dimensions of the two-channel tube are reduced by the thickness of one outer wall, with the above dimensions this results in a reduction in the bore of more than 10%, which is equivalent to a reduction in cross-sectional area of approx. 20%. By this means it is possible according to the invention to create space in the outer auditory canal on the hearing aid device itself for venting (e.g. via a venting hole) in order to reduce the occlusion effect. This is important in particular for an ITE-type hearing aid, for this is where the greatest problems with occlusion are encountered.

Furthermore it is thanks to the use of the multi-channel tube that a direct access to the auditory canal microphone within the hearing aid device is possible in the first place.

In addition, a cerumen protection element can be attached at a free end of the multi-channel tube for an aperture of the auditory canal microphone channel. Said cerumen protection element can also be designed as replaceable if necessary. This applies equally for the earpiece channel of the multi-channel tube.

In a preferred embodiment of the invention, the earpiece and the auditory canal microphone are preferably glued one on top of the other to form an acoustic unit within the hearing aid device, with the multi-channel tube according to the invention being connectable to said acoustic unit. In this arrangement the apertures of the acoustic module for the auditory canal microphone channel and the earpiece channel preferably lie either on one side or on two different sides of the acoustic unit, which sides in the latter case are preferably arranged at an essentially 90° angle.

In the case of an ITE hearing aid device, the multi-channel tube is preferably disposed in/on the ITE is such a way that when the ITE is inserted into an ear, the channel that is smallest in terms of its cross-sectional area is disposed as far away as possible from a wall of the outer auditory canal so that said channel cannot be afflicted so quickly by cerumen, which would necessitate a cleaning of the multi-channel tube. In this case it can depend on the type of hearing aid device, the outer ear of the hearing aid device wearer, and the outer auditory canal whether it is necessary to twist the two longitudinal ends of the multi-channel tube relative to each other so as to ensure on the one hand that the hearing aid device is in the right position in the ear and on the other hand that the multi-channel tube is in the right position in the outer auditory canal.

Further embodiments of the invention will emerge from the remaining dependent claims.

The invention is explained in more detail below with the aid of exemplary embodiments and with reference to the accompanying drawing, in which:

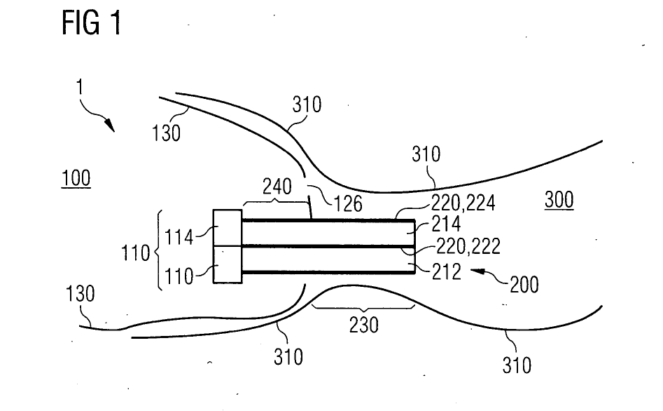

FIG. 1 shows in a schematic representation a first embodiment of an inventive hearing aid device with multi-channel tube which projects into an outer auditory canal of a human ear;

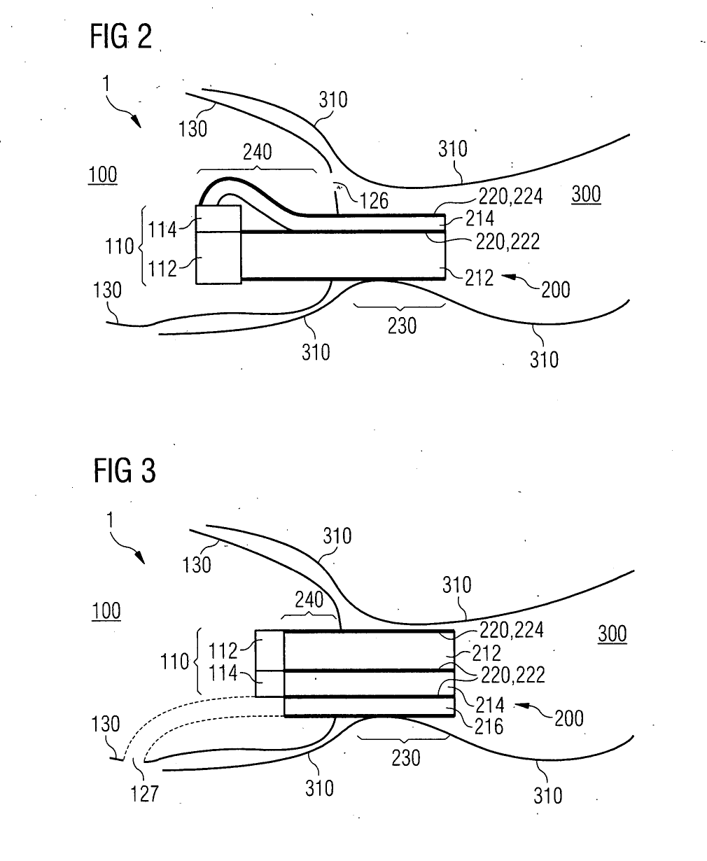

FIG. 2 shows a second embodiment of the inventive hearing aid device according to a position shown in FIG. 1;

FIG. 3 shows a third embodiment of the inventive hearing aid device according to a position shown in FIG. 1;

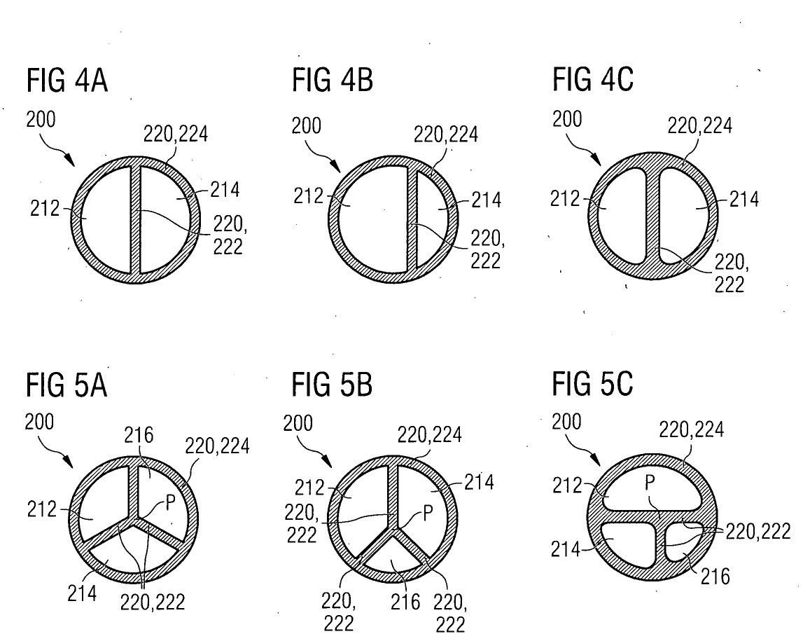

FIG. 4 shows three cross-sectional representations (FIG. 4a-4c) of an inventive multi-channel tube embodied as a two-channel tube; and

FIG. 5 shows three cross-sectional representations (FIG. 5a-5c) of an inventive multi-channel tube embodied as a three-channel tube.

The following statements relate to an in-the-ear (ITE) hearing aid, wherein the ITE can be inserted at least partially into an outer auditory canal of a human ear and in the inserted state of the ITE the free end of an inventive multi-channel tube projects into the outer auditory canal. The invention is not, however, intended to be limited to ITE devices, but rather is intended to encompass all hearing aid devices, e.g. a behind-the-ear (BTE) hearing aid or its otoplastic, a headset, a (miniature) telephone, or similar hearing aid devices.

FIG. 1 shows a first embodiment of a hearing aid device 1 according to the invention, wherein an exterior side 130 or, as the case may be, a wall 130 of the hearing aid device 1 is disposed partially in or on an outer auditory canal 300 of a human ear. In this arrangement a section of the exterior side 130 of the hearing aid device 1 preferably rests against an auditory canal wall 310.

A multi-channel tube 200 projects backwards from the hearing aid device 1 into the outer auditory canal 300 and its free end section 230 extends at least partially into the outer auditory canal 300. In this arrangement the multi-channel tube 200 is accommodated with a bound section 240 in the hearing aid device 1 and is acoustically coupled or connected to an acoustic module 110 within the hearing aid device 1.

The acoustic module 110 has an earpiece 112 or, as the case may be, a loudspeaker 112 and an auditory canal microphone 114. In this arrangement, earpiece 112 and auditory canal microphone 114 are secured, preferably adhesively bonded, together on two sides to a supporting structure. Absorbent (“damping”) materials can be provided between supporting structure and auditory canal microphone 114 and/or between supporting structure and earpiece 112. Reference is explicitly made at this juncture to EP 1 377 119 A2, which teaches an acoustic module of this type. The disclosure of the cited publication is intended to be expressly incorporated herein. It should, however, be noted that one or both of the microphones taught in EP 1 377 119 A2 (ambient microphones) are intended to correspond in this case to the auditory canal microphone 114.

It is, however, also possible to connect the inventive multi-channel tube 200, not to an individual acoustic module 110, but separately to an earpiece 112 and to an auditory canal microphone 114, where earpiece 112 and auditory canal microphone 114 can be provided at different positions within the hearing aid device 1 (not shown in the drawing). In this case it is not necessary to embody the two channels 212, 214 of the multi-channel tube 200 to be of equal length. It is entirely possible for one of the two channels 212, 214 to have a longer bound longitudinal end section 240, with the multi-channel tube 200 preferably being slit in its internal partition 222. This is equally possible for the free end section 230.

In the embodiment shown in FIG. 1, the multi-channel tube 200 is implemented as a two-channel tube 200 which has an earpiece channel 212 and an auditory canal microphone channel 214. In this arrangement the earpiece channel 212 is acoustically connected to the earpiece 112 or, as the case, loudspeaker 112 and the auditory canal microphone channel 214 is acoustically connected to the auditory canal microphone 114. In the hearing aid device 1 inserted into the ear, the multi-channel tube 200 preferably projects so far into the outer auditory canal 300 that it bridges a constriction in the outer auditory canal 300.

In the exemplary embodiment shown in FIG. 1, the two channels 212, 214 of the multi-channel tube 200 are embodied to be of equal length and open out on one side into the acoustic module 110, where they are connected to the earpiece 112 or, as the case may be, the auditory canal microphone 114, the earpiece channel 212 directing sound waves from the earpiece 112 into the outer auditory canal 300 and the auditory canal microphone channel 214 directing sound waves from the outer auditory canal 300 to the auditory canal microphone 114.

In addition, in its wall 130 the hearing aid device 1 preferably has a venting 126 or, as the case may be, a vent hole 126. Said venting 126 is freely acoustically connected to an exterior side of the hearing aid device 1 (i.e. outside the ear) in order to achieve an equalization of pressure when the hearing aid device 1 is inserted into the ear. Preferably said venting channel 126 can also serve to reduce the occlusion caused by the inserted hearing aid device 1. This is dependent on a diameter of the venting 126 or, as the case may be, on a diameter available for the venting 126.

FIG. 2 shows a second embodiment of the inventive hearing aid device 1, wherein the two acoustic ports of the acoustic module 110 are not—as shown in FIG. 1—accessible from the same side. In the exemplary embodiment shown, these are located on two sides of the acoustic module 110. In the exemplary embodiment shown, these two sides are arranged at a 90° angle to each other.

The bound end section 240 of the multi-channel tube 200 shown in FIG. 2 is split in sections, such that the comparatively longer auditory canal microphone channel 214 branches off from the earpiece channel 212, thereby enabling the acoustic module 110 to make acoustic contact on another side. This can, of course, also be realized in the reverse manner.

FIG. 2 also shows—in contrast to FIG. 1, which depicts equal-sized channels 212, 214 in terms of length and cross-section—a smaller, compared to the earpiece channel 212, auditory canal microphone channel 214 of the multi-channel tube 200. Quite generally it is preferable to embody the earpiece channel 212 to be greater in cross-section than the auditory canal microphone channel 214, since the earpiece channel 212 has to transmit a certain sound energy, whereas in the case of the auditory canal microphone channel 214 it is essentially sufficient to transmit information. Furthermore an embodiment is in turn, of course, also possible in which the earpiece 112 and auditory canal microphone 114 are not combined to form an acoustic module 110.

FIG. 3 shows a multi-channel tube 200 embodied as a three-channel tube 200, wherein a venting channel 216 is provided in addition to the earpiece channel 212 and the auditory canal microphone channel 214. This enables a position of the venting 126, as shown in FIGS. 1 and 2, to be omitted. However, this does not necessarily have to be the case. The venting 126 shown in FIGS. 2 and 3 can nonetheless be provided, which is of advantage in particular for a pressure equalization when the hearing aid device 1 is inserted into the ear.

The venting channel 216 of the multi-channel tube 200 preferably leads to a venting 127 of the hearing aid device 1 which, with the hearing aid device 1 in its inserted state, is preferably arranged outside or on the ear. In this arrangement the venting channel 216 or a continuation of the venting channel 216 is led past the acoustic module 110, if the latter is present; otherwise the venting channel 216 preferably leads past the earpiece 112 and/or the auditory canal microphone 114. This can happen either in that the venting channel 216 is embodied to be longer than the remainder of the multi-channel tube 200, or the venting channel 216 is connected inside the hearing aid device 1 to a channel that is present therein and leads to the venting 127, or else it simply just ends freely in the hearing aid device 1.

In an embodiment according to FIG. 3, the earpiece channel 212 is preferably in turn greatest in its cross-section, whereby it is again preferable that the cross-section of the auditory canal microphone channel 214 is greater than the cross-section of the venting channel 216.

In all the embodiments of the invention it is not necessary to combine earpiece 112 and auditory canal microphone 114 in an acoustic module 110, but instead they can be provided separately from each other in the hearing aid device 1. As a result it can happen that, for example, all channels 212, 214, (216, if present) of the multi-channel tube 200 have a different length. In this case the partition wall 222 is then once again split, preferably centrally, in each case between the channels 212, 214, 216.

In all the embodiments of the invention it is preferable that the smallest channel (212, 214,) 216 of the multi-channel tube 200 or the smallest channels (212,) 214, 216 of the multi-channel tube 200 are provided in the case of an inserted hearing aid device 1 in/on the auditory canal 300 in such a way that as far as possible they do not bear against the auditory canal inner wall 310. This serves to protect against cerumen, which represents a potentially greater risk of blockage for the smaller channels (212,) 214, 216 than for the larger channels 212, (214, 216).

In order to find an optimal position of the multi-channel tube 200 in the outer auditory canal 300 when the hearing aid device 1 is inserted, it may be necessary to twist the free end or, as the case may be, the free end section 230 of the multi-channel tube 200 relative to the bound end or, as the case may be, its bound end section 240, or relative to the hearing aid device 1 (not shown in the drawing).

FIGS. 4a, 4b and 4c in turn show embodiments of the multi-channel tube 200 embodied as a two-channel tube 200. In this case FIGS. 4a and 4c show a multi-channel tube 200 represented in longitudinal section in FIG. 1, and FIG. 4B shows a multi-channel tube 200 represented in longitudinal section in FIG. 2. FIGS. 4a and 4c show a multi-channel tube 200 having two equal-sized chambers 212, 214 which are subdivided by the internal partition 222 or a membrane 222 into channels 212, 214 which are equal in size in terms of cross-section. In particular FIG. 4c shows a preferred embodiment of the invention wherein the transitions between an inside of an outer wall 224 and the internal partition 222 are rounded off. FIG. 4b shows a multi-channel tube 200 having an earpiece channel 212 with a larger cross-section and an auditory canal microphone channel 214 with a smaller cross-section.

FIGS. 5a, 5b and 5c show embodiments of the multi-channel tube 200 embodied as a three-channel tube 200. In this case FIG. 5a shows a three-channel tube 200 having equal-sized channels 212, 214, 216 in terms of cross-section, which are separated from one another by internal partitions 222 in each case. FIG. 5b shows an earpiece channel 212 which is just as large in terms of cross-section as an auditory canal microphone channel 214, with the smaller (in terms of cross-section) venting channel 216 being embodied between said two channels. FIG. 5c in turn shows three channels 212, 214, 216 which are different in size in terms of cross-section, with the cross-sectional area of the earpiece channel 212 being greater than that of the auditory canal microphone channel 214 whose cross-sectional area is in turn greater than that of the venting channel 216. FIG. 5c also shows an inside of the outer wall 224 of the three-channel tube 200, said inside being rounded off with the respective internal partition 222, as well as rounded-off transitions between the internal partitions 222.

A meeting point P of internal partitions 222 in the case of a three-channel tube 200 can be arbitrarily chosen within the cross-section of the three-channel tube 200. It is possible to position said point in the center (see FIG. 5a), in which case the channels 212, 214, 216 cover a more or less large (circular) sector of the cross-sectional area of the three-channel tube 200. Said meeting point P can, however, also be located off-center (see FIGS. 5b and 5c), in which case the internal partitions 222 can meet one another at right angles (see FIG. 5c) or not at right angles (see FIG. 5b).

However, the meeting point P can also be shifted toward the outer wall 224 of the three-channel tube 200, thereby producing a three-channel tube 200 whose two internal partitions 222 (not shown in the drawing) no longer have a meeting point P within the cross-sections of the three-channel tube 200. In this case the cross-sections of the channels 212, 214, 216 are essentially triangular. If said point divides itself on the outer wall 224, there are produced in the three-channel tube 200 two internal partitions 222 which are arranged more or less in parallel with each other.

Preferably the multi-channel tube 200 is essentially circular in cross-section. It can, however, be advantageous—depending on the shape of the outer auditory canal 300 or, as the case may be, a constriction of the auditory canal 300—to use a multi-channel tube 200 which is ellipsoidal in cross-section.

1.-16. (canceled)

17. A hearing aid device, comprising:
a multi-channel tube with a earpiece channel and a microphone channel and with a free end section for insertion into an outer auditory canal of a ear;
an earpiece acoustically connected to the earpiece channel; and
an auditory canal microphone acoustically connected to the microphone channel.

18. A hearing aid device as claimed in claim 17, wherein the earpiece is acoustically connected to the earpiece channel inside the hearing aid device, and wherein the auditory canal microphone acoustically connected to the microphone channel inside the hearing aid device.

19. A hearing aid device as claimed in claim 17, wherein the hearing device has a section from which the multi-channel tube projects, and wherein the section is in an ear or on an ear.

20. The hearing aid device as claimed in claim 18, wherein the multi-channel tube is a three-channel tube, and wherein the channels of the multi-channel tube cover a sector of a cross-sectional area of the three-channel tube.

21. The hearing aid device as claimed in claim 18, wherein during operation of the hearing aid device sound is transported from the earpiece through the earpiece channel into the auditory canal and sound is transported from the auditory canal through the auditory canal microphone channel to the auditory canal microphone.

22. The hearing aid device as claimed in claim 18, wherein the earpiece and the auditory canal microphone form a electromagnetically shielded acoustic unit.

23. The hearing aid device as claimed in claim 18, wherein an aperture in the earpiece for an acoustic coupling of the earpiece channel and an aperture in the auditory canal microphone for the acoustic coupling of the auditory canal microphone channel are positioned relative to each other in such a way that bound end sections of the channels of the multi-channel tube essentially possess the same length.

24. The hearing aid device as claimed in claim 18, wherein the earpiece has an aperture for the earpiece channel and the auditory canal microphone has an aperture for the auditory canal microphone channel, and wherein the aperture for the earpiece channel and the aperture for the auditory canal microphone channel are arranged on a single side.

25. The hearing aid device as claimed in claim 18, wherein an aperture in the earpiece for an acoustic coupling of the earpiece channel and an aperture in the auditory canal microphone for the acoustic coupling of the auditory canal microphone channel are positioned relative to each other in such a way that a bound end section of the channels of the multi-channel tube have different lengths.

26. The hearing aid device as claimed in claim 25, wherein the earpiece and the auditory canal microphone are arranged relative to each other in such a way that an aperture for the auditory canal microphone channel and an aperture for the earpiece channel are arranged on two sides assuming a substantially 90° angle to each other.

27. The hearing aid device as claimed in claim 18, wherein a cross-sectional area of the auditory canal microphone channel is smaller than or equal in size to a cross-sectional area of the earpiece channel.

28. The hearing aid device as claimed in claim 18, wherein the multi-channel tube has a venting channel to vent the hearing aid device.

29. The hearing aid device as claimed in claim 28, wherein a cross-sectional area of the venting channel is smaller than or equal in size to a cross-sectional area of the auditory canal microphone channel.

30. The hearing aid device as claimed in claim 18, wherein the channel with a smallest cross-sectional area or the channels with the smallest cross-sectional area are disposed away from an auditory canal wall to ensure protection against cerumen based upon a positioning in the multi-channel tube.

31. The hearing aid device as claimed in claim 18, wherein the channels of the multi-channel tube are substantially insulated from one another acoustically based upon an internal partition.

32. The hearing aid device as claimed in claim 18, wherein the walls of the multi-channel tube have rounded-off transitions on the inside of the multi-channel tube.

33. The hearing aid device as claimed in claim 18, wherein the acoustic unit has a signal processing unit to suppress feedback, wherein the signal processing unit is electrically connected to the earpiece and the auditory canal microphone.

34. An in the ear hearing aid device, comprising:
a multi-channel tube with a earpiece channel and a microphone channel and with a free end section for insertion into an outer auditory canal of a ear;
an earpiece acoustically connected to the earpiece channel inside the hearing aid device; and
an auditory canal microphone acoustically connected to the microphone channel inside the hearing aid device.

35. The hearing aid device as claimed in claim 34, wherein a cross-sectional area of the auditory canal microphone channel is smaller than or equal in size to a cross-sectional area of the earpiece channel.

36. The hearing aid device as claimed in claim 35, wherein the multi-channel tube has a venting channel to vent the hearing aid device, wherein a cross-sectional area of the venting channel is smaller than or equal in size to a cross-sectional area of the auditory canal microphone channel and wherein the channel with a smallest cross-sectional area or the channels with a small cross-sectional area are disposed away from an auditory canal wall.
